(19) United States
(12) Patent Application Publication
(10) Pub. No.: US 2026/0160041 A1
(43) Pub. Date: Jun. 11, 2026

(54) WORK MACHINE

(71) Applicant: KOMATSU LTD., Tokyo (JP)

(72) Inventor: Yuya MOCHIMARU, Tokyo (JP)

(21) Appl. No.: 18/709,987

(22) PCT Filed: Nov. 15, 2022
(86) PCT No.: PCT/JP2022/042422

§ 371 Date: May 14, 2024

(30) Foreign Application Priority Data
Dec. 3, 2021 (JP) 2021-197392

(51) Int. Cl. E02F 9/18

(52) U.S. Cl. CPC E02F 9/18

(57) ABSTRACT

A work machine includes a vehicle body, a counterweight attachable to and detachable from the vehicle body, an attachment and detachment device disposed in a storage portion provided in the counterweight, and an upper surface cover attached to an upper side of the attachment and detachment device. The counterweight is attached to the vehicle body. The attachment and detachment device expands and contracts in an up-and-down direction through an opening provided above the storage portion in attachment of the counterweight to and detachment of the counterweight from the vehicle body. The upper surface cover is configured to move in the up-and-down direction as the attachment and detachment device extends and retracts. The upper surface cover is configured to close the opening at a lowest position.

### CROSS-REFERENCE TO RELATED APPLICATIONS

This application is a U.S. National stage application of International Application No. PCT/JP2022/042422, filed on Nov. 15, 2022. This U.S. National stage application claims priority under 35 U.S.C. § 119(a) to Japanese Patent Application No. 2021-197392, filed in Japan on Dec. 3, 2021, the entire contents of which are hereby incorporated herein by reference.

### BACKGROUND

### Technical Field

The present invention relates to a work machine.

### Background Information

A hydraulic excavator, exemplified as a work machine, is equipped with a counterweight. When the hydraulic excavator is of a large size, the counterweight is configured to be attachable/detachable to/from a vehicle body of the hydraulic excavator to meet transportation regulations (see e.g., Japan Laid-open Patent Application Publication No. H11-1940).

The hydraulic excavator shown in Japan Laid-open Patent Application Publication No. H11-1940 is provided with an attachment/detachment device attaching/detaching the counterweight to/from the vehicle body. When the counterweight is attached to the vehicle body, the attachment/detachment device is disposed in a storage portion that is a cutout-shaped portion of the counterweight. An upper surface cover is provided to prevent soil and sand from entering through an opening of the cutout-shaped portion. The upper surface cover is attached to the vehicle body by a hinge so as to be openable and closable, and the upper surface cover opens and closes automatically by expanding and contracting of the attachment/detachment device in the up-down direction.

### SUMMARY

However, in the configuration of Japan Laid-open Patent Application Publication No. H11-1940, the upper surface cover vibrates around the hinge due to vibrations caused by the operation of the hydraulic excavator, causing the upper surface cover flapping and posing the risk of rainwater, soil, sand, etc. entering the opening.

An object of the present disclosure is to provide a work machine with which it is possible to prevent the intrusion of rainwater, soil, sand, and the like through an opening formed in a counterweight.

A work machine according to a first aspect of the present disclosure includes a vehicle body, a counterweight, an actuator, and an upper surface cover. The counterweight is attachable/detachable to/from the vehicle body. The actuator is disposed in a storage portion provided in the counterweight, with the counterweight being attached to the vehicle body. The actuator expands/contracts in an up-and-down direction through an opening provided above the storage portion in attachment/detachment of the counterweight to/from the vehicle body. The upper surface cover is attached to an upper side of the attachment/detachment device. The upper surface cover is configured to move in the up-and-down direction as the actuator extends and retracts, the upper surface cover is configured to close the opening at a lowest position.

According to an aspect of the present disclosure, there is provided a work machine with which it is possible to prevent the intrusion of rainwater, soil, sand, and the like through an opening formed in a counterweight.

### BRIEF DESCRIPTION OF THE DRAWINGS

FIG. 1 is a perspective view of a hydraulic excavator according to a preferred embodiment of the present disclosure.

FIG. 2 is a perspective view of a frame of a revolving unit, a counterweight, and an attachment/detachment device as seen from ahead in the hydraulic excavator according to the preferred embodiment of the present disclosure.

FIG. 3 is a perspective view of a condition made when the counterweight is separated from the frame of the revolving unit in the hydraulic excavator according to the preferred embodiment of the present disclosure.

FIG. 4 is a perspective view of a condition made when the counterweight is separated from the frame of the revolving unit in the hydraulic excavator according to the preferred embodiment of the present disclosure.

FIG. 5A includes a perspective view of an attachment/detachment device and an upper surface cover in the hydraulic excavator according to the preferred embodiment of the present disclosure and FIG. 5B includes a perspective view of a modified example of a sprocket.

FIG. 6 is a perspective view of a condition made when a cylinder is expanded from the state thereof shown in FIG. 2.

FIG. 7 is a perspective view for explaining connection of chains to the revolving unit and the counterweight in the hydraulic excavator according to the present preferred embodiment of the present disclosure.

FIG. 8A is a view of an upper part of the attachment/detachment device and the upper surface cover as seen from a side of a vehicle body in the hydraulic excavator according to the present preferred embodiment of the present disclosure.

FIG. 8B is a view of the upper part of the attachment/detachment device as seen from a left side in FIG. 8A.

FIG. 8C is a cross-sectional view of the upper part of the attachment/detachment device as seen from a side of the vehicle body in the hydraulic excavator according to the present preferred embodiment of the present disclosure.

FIG. 8D is a perspective view of the upper part of the attachment/detachment device and the upper surface cover in the hydraulic excavator according to the present preferred embodiment of the present disclosure.

FIG. 9 is a cross-sectional view of a condition made when the counterweight is attached to the vehicle body in the hydraulic excavator according to the present preferred embodiment of the present disclosure.

FIG. 10A is a cross-sectional view of a condition made when the cylinder is expanded from the state thereof shown in FIG. 9.

FIG. 10B is a perspective view of the entirety of the revolving unit corresponding to the state shown in FIG. 10A.

FIG. 11A is a cross-sectional view of a condition made when the counterweight is moved downward by contracting the cylinder from the state thereof shown in FIG. 10A.

FIG. 11B is a perspective view of the entirety of the revolving unit corresponding to the state shown in FIG. 10A.

FIG. 12A and FIG. 12B include views for explaining a function of a spring disposed on a shoulder bolt in the hydraulic excavator according to the present preferred embodiment of the present disclosure.

### DETAILED DESCRIPTION OF EMBODIMENT(S)

A hydraulic excavator, exemplified as a work machine according to the present disclosure, will be hereinafter explained with reference to drawings.

### Configuration

### (Overview of Hydraulic Excavator 1)

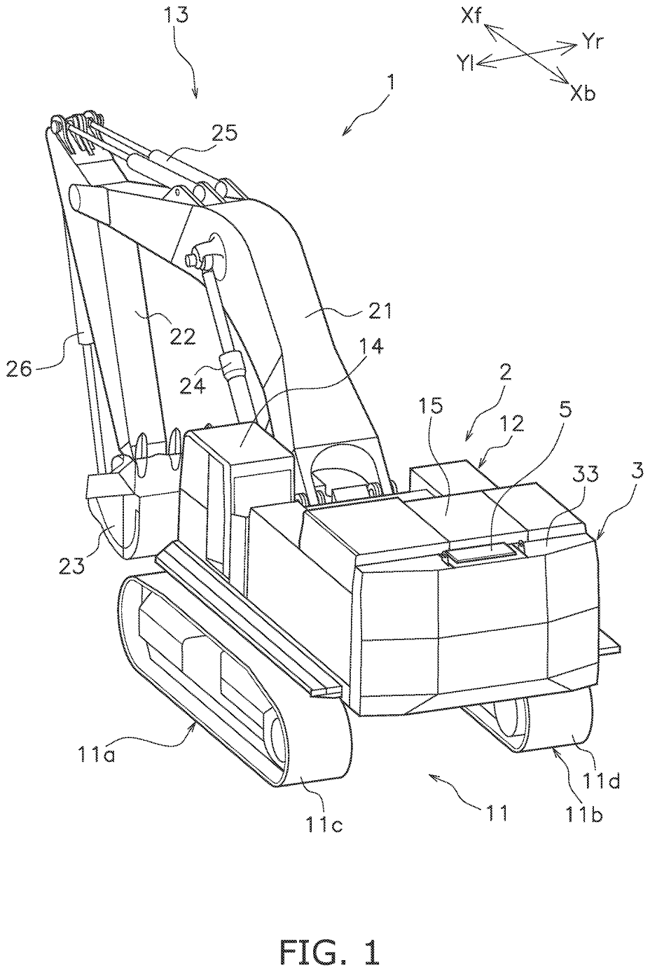

FIG. 1 is a schematic view of a configuration of a hydraulic excavator 1 according to the present preferred embodiment.

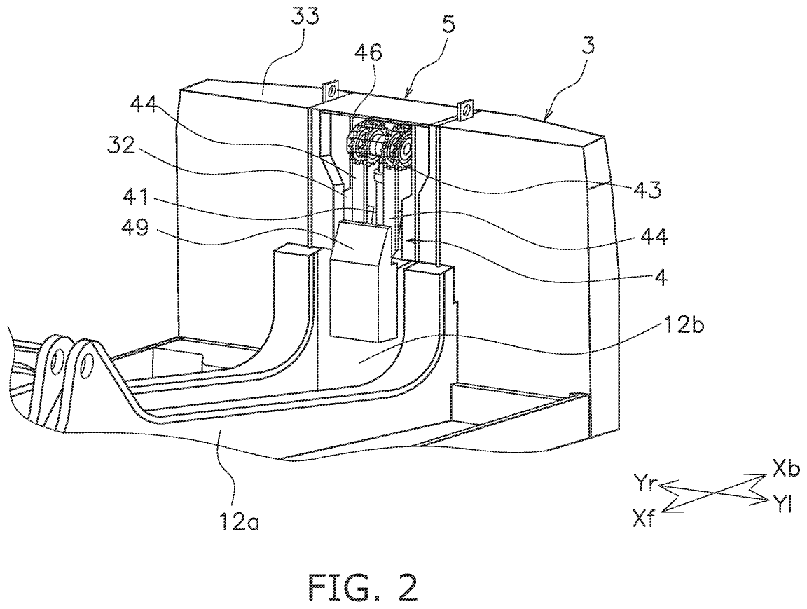

The hydraulic excavator 1 (exemplary work machine) includes a vehicle body 2, a counterweight 3, an attachment/detachment device 4 (see FIG. 2), and an upper surface cover 5. As shown in FIG. 1, the vehicle body 2 includes a traveling unit 11, a revolving unit 12, and a work implement 13. The traveling unit 11 includes a pair of traveling devices 11a and 11b. Each traveling device 11a, 11b includes a crawler belt 11c, 11d. When a drive motor is rotated by a drive force transmitted thereto from an engine, the crawler belts 11c and 11d are driven, whereby the hydraulic excavator 1 is caused to travel.

The revolving unit 12 is disposed on the traveling unit 11. The revolving unit 12 is configured to be enabled to revolve about an axis oriented along an up-and-down direction with respect to the traveling unit 11 by a revolving device (not shown in the drawings). A cab 14, serving as an operating room in which an operator is seated in operation, is installed in a left position on a front part of the revolving unit 12. An operator seat, levers for operating the work implement 13, a variety of display devices, and so forth are disposed in the interior of the cab 14. An engine compartment 15, in which the engine is stored, is disposed behind the cab 14.

It should be noted that in the present preferred embodiment, unless otherwise specified, directional terms “front”, “rear (back)”, “right”, and “left” will be explained with reference to the operator seat inside the cab 14. When the operator seat faces straight forward, a direction in which the operator seat is oriented is defined as a front direction (see arrow Xf); on the other hand, a direction opposed to the front direction is defined as a rear (back) direction (see arrow Xb). When the operator seat faces straight forward, the right side and the left side in a lateral direction are defined as a right direction (see arrow Yr) and a left direction (see arrow YI), respectively. Besides, in the present specification, unless otherwise specified, the term “up-and-down direction” indicates a direction oriented when the hydraulic excavator 1 takes a horizontal position without tilting.

The work implement 13 is attached to a center position on the front part of the revolving unit 12. As shown in FIG. 1, the work implement 13 includes a boom 21, an arm 22, and an excavating bucket 23. The boom 21 is coupled at the base end thereof to the revolving unit 12 in a pivotable manner. Besides, the boom 21 is coupled at the distal end thereof to the base end of the arm 22 in a pivotable manner. The arm 22 is coupled at the distal end thereof to the excavating bucket 23 in a pivotable manner. The excavating bucket 23 is attached to the arm 22 such that the opening thereof is enabled to face toward the revolving unit 12 (rearward). When the excavating bucket 23 is attached in such an orientation as herein described, the hydraulic excavator 1 is referred to as a backhoe.

Hydraulic cylinders 24 to 26 (a boom cylinder 24, an arm cylinder 25, and a bucket cylinder 26) are disposed in one-to-one correspondence to the boom 21, the arm 22, and the excavating bucket 23. When the hydraulic cylinders 24 to 26 are driven, the work implement 13 is driven. Accordingly, such a work as excavation is performed.

The counterweight 3 is attached to the rear side of the vehicle body 2. The counterweight 3 is attachable/detachable to/from the vehicle body 2. The attachment/detachment device 4 mounts/demounts the counterweight 3 to/from the vehicle body 2, although this will be explained below in detail.

### (Counterweight 3)

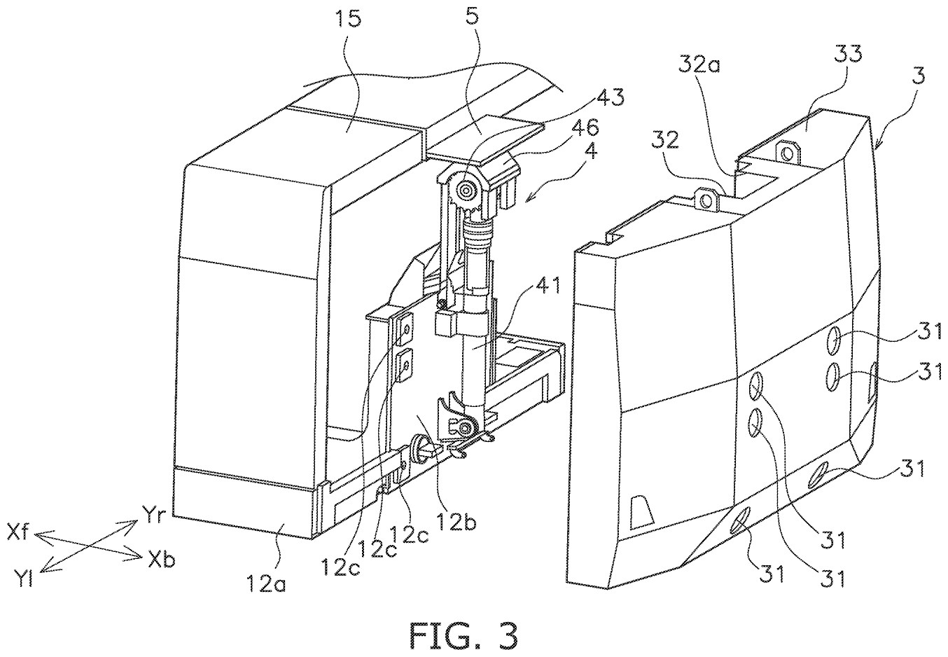

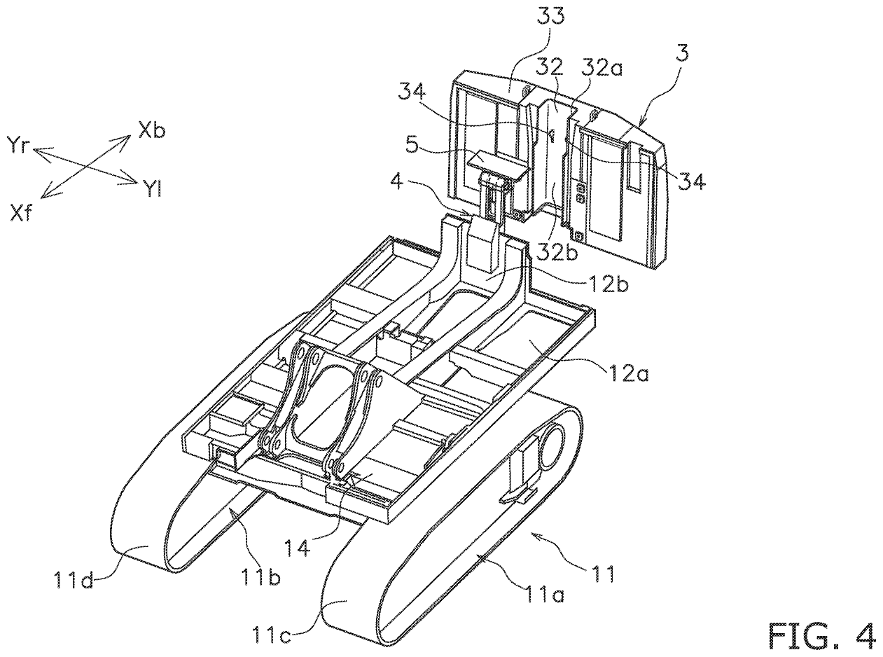

FIG. 2 is a perspective view of a frame 12a of the revolving unit 12, the counterweight 3, and the attachment/detachment device 4 as seen from ahead. FIG. 3 is a perspective view of a condition made when the counterweight 3 is separated from the frame 12a of the revolving unit 12 as seen from left rear. FIG. 4 is a perspective view of a condition made when the counterweight 3 is separated from the frame 12a as seen from front above.

The counterweight 3 is attached to a frame portion 12b disposed in a rear part of the frame 12a of the revolving unit 12. The frame portion 12b is a plate-shaped portion extending perpendicular to a back-and-forth direction.

The counterweight 3 is provided with a plurality of through holes 31 penetrating therethrough in the back and-forth direction. As shown in FIG. 3, in the present preferred embodiment, the counterweight 3 is provided with six through holes 31. The six through holes 31 are composed of two sets of through holes 31 aligned in the right-and-left direction; besides, each set of through holes 31 is composed of three through holes 31 aligned along the up-and-down direction. The frame portion 12b is provided with holes 12c, into which bolts are inserted, in one-to-one corresponding positions to the through holes 31. The bolts are inserted from behind into the insertion holes 12c via the through holes 31, whereby the counterweight 3 is fixed to the frame portion 12b. It should be noted that only three of the insertion holes 12c, disposed on the left lateral surface side, are shown in FIG. 3, whereas the remaining three of the insertion holes 12c, disposed on the right lateral surface side, are hidden by the attachment/detachment device 4 and hence are not shown in FIG. 3.

As shown in FIG. 4, the counterweight 3 is provided with a recessed portion 32 (exemplary storage portion) along the up-and-down direction. Due to the recessed portion 32, a cutout-shaped portion is formed in the counterweight 3. As shown in FIG. 2, while the counterweight 3 is attached to the vehicle body 2, the attachment/detachment device 4 is disposed in the recessed portion 32. The recessed portion 32 is shaped to extend from an upper surface 33 to a lower surface in the counterweight 3. As shown in FIGS. 3 and 4, the upper surface 33 is provided with an opening 32a due to the recessed portion 32. The opening 32a is closed by the upper surface cover 5.

Besides, as shown in FIG. 4, two brackets 34, each of which is made in shape of a plate extending along the up-and-down direction, are disposed on a surface portion 32b corresponding to the rearmost portion of the recessed portion 32 among the front side surface of the counterweight 3. Chains 44 (to be described) are connected at end portions 44b thereof to the brackets 34, respectively.

### (Attachment/Detachment Device 4)

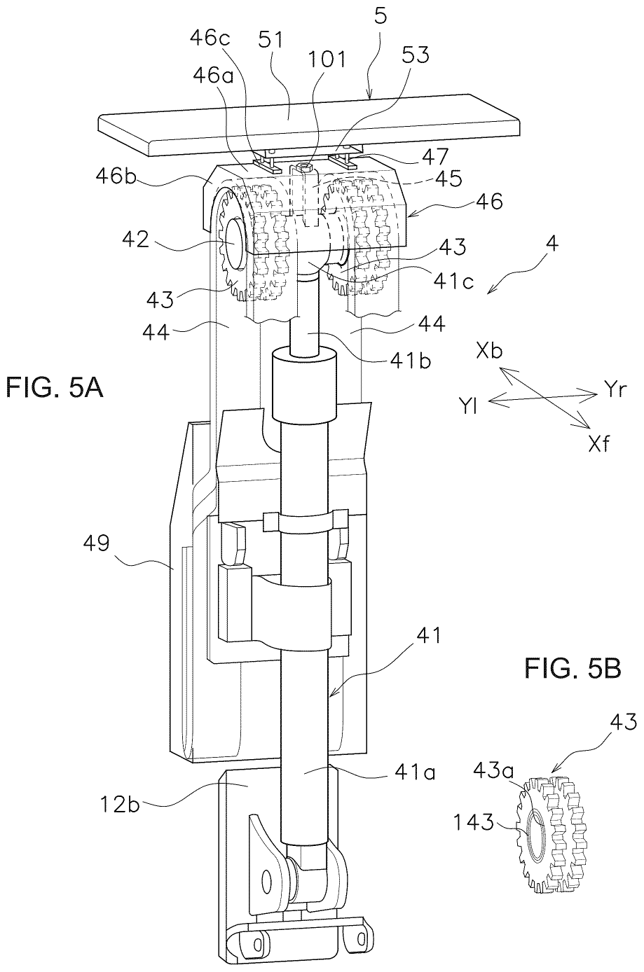

As shown in FIG. 5A, the attachment/detachment device 4 is disposed on the rear side of the vehicle body 2. The upper surface cover 5 is disposed on the upper side of the attachment/detachment device 4.

FIG. 5A is a perspective view of the attachment/detachment device 4.

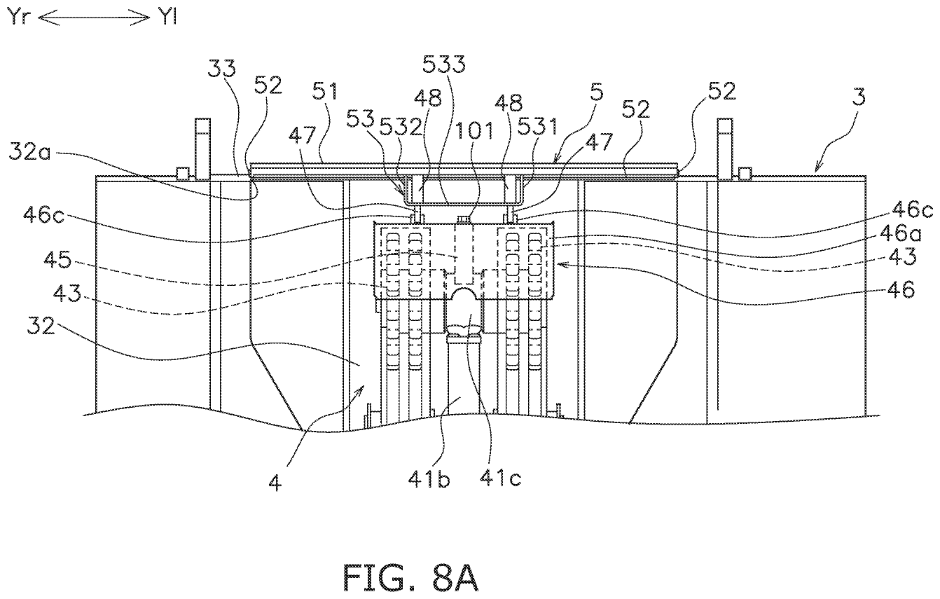

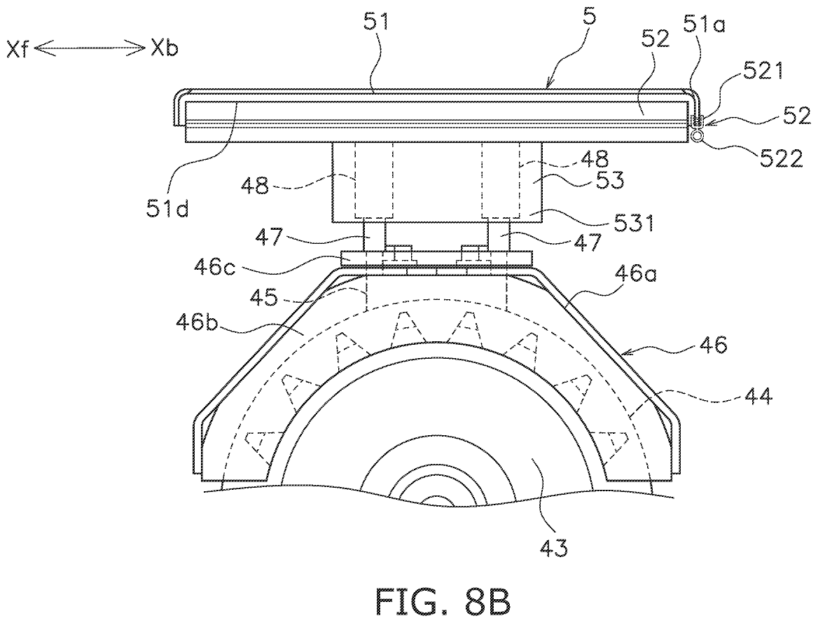

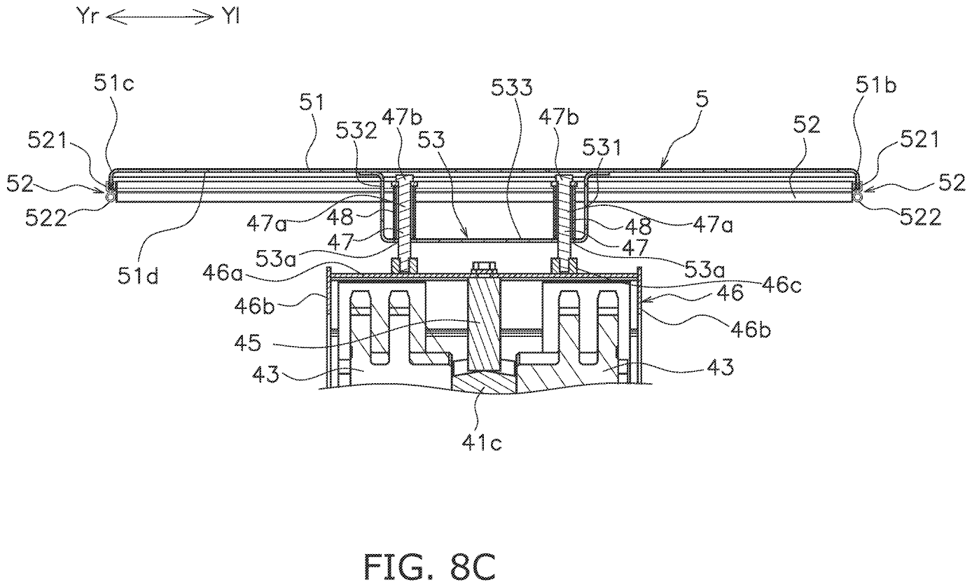

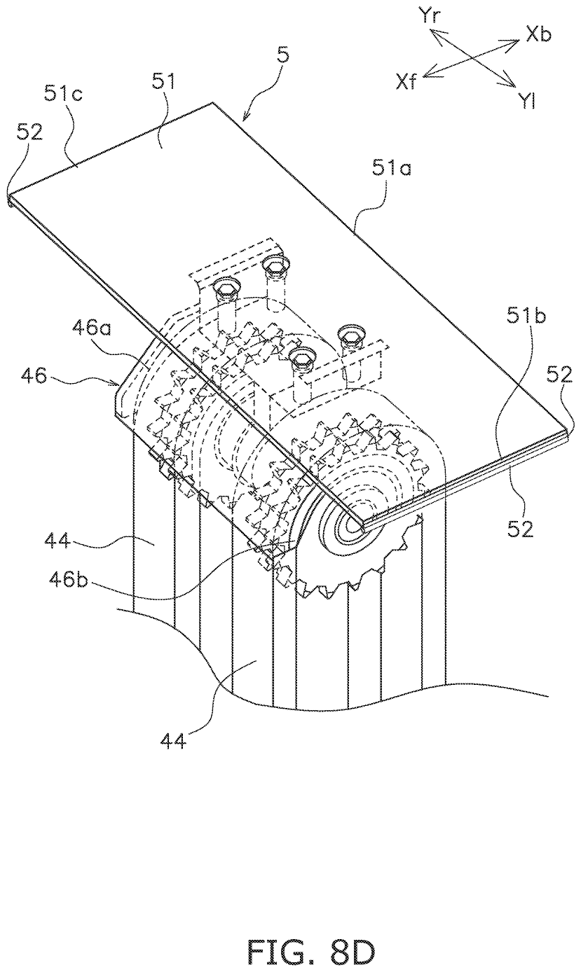

As shown in FIG. 2, the attachment/detachment device 4 includes a cylinder 41, a shaft member 42, sprockets 43, the chains 44, a support base 45, a sprocket cover 46 (an example of a fixing portion), a shoulder bolt 47 (an example of a support member), and a spring 48 (an example of an elastic member; see FIG. 8C).

As shown in FIG. 3, the cylinder 41 is attached to the frame portion 12b of the rear part of the revolving unit 12. The frame portion 12b is a portion made in shape of a plate extending perpendicular to the back-and-forth direction. The cylinder 41 is fixed to the rear surface of the frame portion 12b. The cylinder 41 is disposed along the up-and-down direction.

When described in detail, as shown in FIG. 5A, the cylinder 41 includes a cylinder tube 41a and a cylinder rod 41b. The cylinder tube 41a is disposed along the up-and-down direction. The cylinder tube 41a is fixed to the rear surface of the frame portion 12b. A piston (not shown in the drawings) is disposed on the lower end of the cylinder rod 41b. The piston is disposed to be movable within the cylinder tube 41a. The upper end of the cylinder rod 41b protrudes upward from the cylinder tube 41a. The internal space of the cylinder tube 41a is divided into a bottom-side space and a rod-side space by the piston.

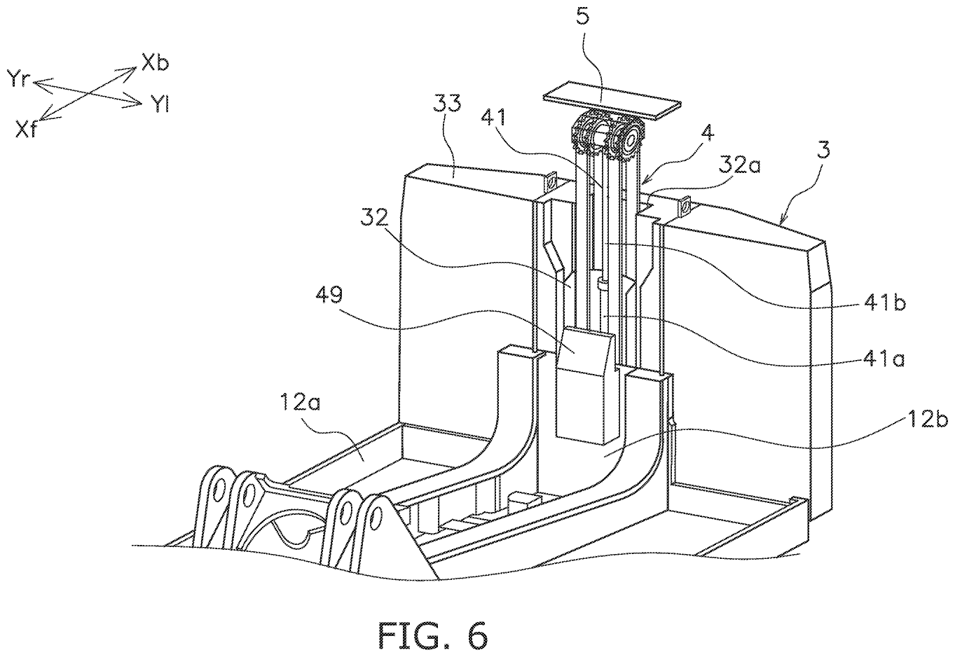

FIG. 6 is a view of a condition made when the cylinder 41 is expanded from the state thereof shown in FIG. 2. When hydraulic oil is supplied to the bottom-side space of the cylinder tube 41a by a pump (not shown in the drawings), while the hydraulic oil, contained in the rod-space of the cylinder tube 41a, is discharged therefrom, the cylinder rod 41b is moved upward with respect to the cylinder tube 41a. Accordingly, the cylinder 41 is expanded as shown in FIG. 6.

Contrarily, when the hydraulic oil, contained in the bottom-side space of the cylinder tube 41a, is discharged therefrom, while the hydraulic oil is supplied to the rod-side space of the cylinder tube 41a, the cylinder rod 41b is moved downward with respect to the cylinder tube 41a. Accordingly, the cylinder 41 is contracted as shown in FIG. 2.

The shaft member 42 is fixed to a distal end 41c of the cylinder rod 41b. The shaft member 42 is disposed along the right-and-left direction. The shaft member 42 protrudes leftward from the distal end 41c, while protruding rightward therefrom.

As shown in FIG. 5A, the sprockets 43 are disposed on both right and left sides of the distal end 41c of the cylinder rod 41b. The sprockets 43 are disposed to be rotatable on the shaft member 42. It should be noted that in the present preferred embodiment, each sprocket 43 is provided with a through hole along the right-and-left direction; besides, the shaft member 42 is inserted into the through hole. When each sprocket 43 is rotated with respect to the shaft member 42, the outer peripheral surface of the shaft member 42 and the inner peripheral surface of the through hole of each sprocket 43 slide against each other, but this is not limited to the configuration. For example, as shown in FIG. 5B, a bearing 143 may be press-fitted into a through hole 43a formed in the sprocket 43. The bearing 143 is disposed between the shaft member 42 and the sprocket 43.

The chains 44 are wound about the sprockets 43, respectively. The chains 44 are connected to the revolving unit 12 and the counterweight 3. The sprockets 43 are disposed on both sides of the distal end 41c of the cylinder rod 41b in the right-and-left direction; hence, the chains 44 are disposed on both right and left sides of the distal end 41c of the cylinder rod 41b as well.

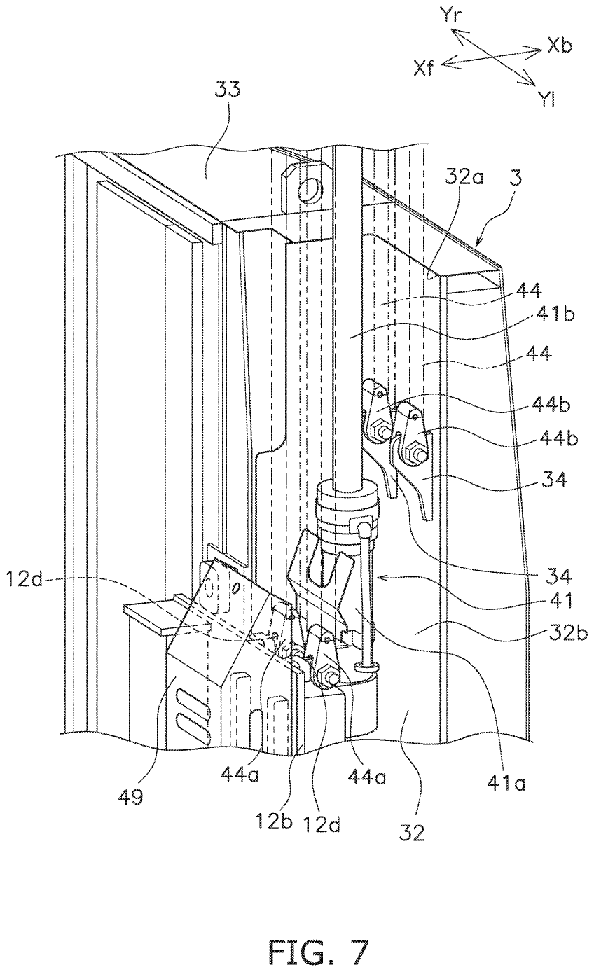

FIG. 7 is a perspective view for explaining connection of the chains 44 to the revolving unit 12 and the counterweight 3. FIG. 7 shows an expanded state of the cylinder 41 to make both ends of the chains 44 visible as much as possible. Besides, FIG. 7 shows structures on the deep side of the paper surface of the chains 44. Also, the chains 44 are depicted with dashed two-dotted line in FIG. 7.

Each of the right and left chains 44 is connected at one end portion 44a to the frame portion 12b. Two brackets 12d are disposed on the rear-side surface of the frame portion 12b. Each bracket 12d includes a plate-shaped portion protruding rearward; besides, the plate-shaped portion is disposed along the up-and-down direction. The end portion 44a of each chain 44 is attached to the plate-shaped portion of each bracket 12d to be pivotable about an axis oriented along the right-and-left direction.

Each chain 44 is connected at the other end portion 44b thereof to the front-side surface of the counterweight 3. The end portion 44b of each chain 44 is attached to each bracket 34 disposed on the surface portion 32b described above to be pivotable about an axis oriented along the right-and-left direction.

FIG. 8A is a view of an upper part of the attachment/detachment device 4 and the upper surface cover 5 as seen from a side of the vehicle body 2. FIG. 8A shows a state in which the cylinder 41 is contracted and the opening 32a is closed by the upper surface cover 5. FIG. 8B is a view of the upper part of the attachment/detachment device 4 as seen from a left side. FIG. 8C is a cross-sectional view of the upper part of the attachment/detachment device 4 as seen from a side of the vehicle body 2. FIG. 8D is a perspective view of the upper part of the attachment/detachment device 4 and the upper surface cover 5.

As shown in FIG. 8A, the support base 45 is fixed to the distal end 41c of the cylinder 41. The support base 45 is disposed on the upper side of the distal end 41c. The support base 45 is provided for supporting the sprocket cover 46.

The sprocket cover 46 is disposed to cover the sprockets 43 from above. As shown in FIG. 8A, the sprocket cover 46 is fixed to the support base 45 from the upper side thereof by a bolt 101. As shown in FIG. 8C, the sprocket cover 46 includes an upper surface portion 46a that covers an upper side of the sprocket 43, and edge portions 46b that extend downward from the left and right ends of the upper surface portion 46a. The gap between the upper surface portion 46a and the sprocket 43 and the gap between the edge portion 46b and the sprocket 43 are formed to a size such that the chain 44 is not able to pass through.

The shoulder bolt 47 is disposed above the upper surface portion 46a of the sprocket cover 46. For example, four shoulder bolts 47 are disposed. Each of the shoulder bolts 47 is disposed along the up-down direction. As shown in FIGS. 8A and 8B, four shoulder bolts 47 are disposed. The four shoulder bolts 47 are composed of two sets of shoulder bolts 47 aligned in the back-and-forth direction; besides, each set of shoulder bolts 47 is composed of two shoulder bolts 47 aligned along the right-and-left direction. Bases 46c for fixing the shoulder bolts 47 are disposed on the upper surface portion 46a. The two bases 46c are arranged side by side in the left-and-right direction, two left-side shoulder bolts 47 are fixed to the left-side base 46c, and two right side shoulder bolts 47 are fixed to the right side base 46c.

The shoulder bolt 47 includes a rod-shaped portion 47a (an example of a penetrating portion) and a head portion 47b. The rod-shaped portion 47a is fixed at the lower end thereof to the base 46c. The head portion 47b is disposed at the upper end of the rod-shaped portion 47a. The head portion 47b has an outer diameter larger than that of the rod-shaped portion 47a. The upper surface cover 5 is disposed on the upper side of the head portions 47b of the four shoulder bolts 47.

Each of springs 48 is disposed around each shoulder bolt 47, as shown in FIG. 8C. The rod-shaped portion 47a of the shoulder bolt 47 passes through the spring 48. The spring 48 is disposed between a flat portion 533 (described later) of the spring support portion 53 of the upper surface cover 5 and the head portions 47b.

### (Upper Surface Cover 5)

As described above, the upper surface cover 5 is disposed above the attachment/detachment device 4. The upper surface cover 5 moves up and down as the cylinder 41 expands and contracts.

When the cylinder 41 is contracted, the upper surface cover 5 is able to abut against the upper surface 33 of the counterweight 3 and close the opening 32a of the recessed portion 32, as shown in FIG. 8A.

As shown in FIG. 8A, the upper surface cover 5 includes a cover body 51, an elastic member 52, and a spring support portion 53. The cover body 51 has a plate shape. The cover body 51 is formed slightly larger than the opening 32a formed on the upper surface 33 of the counterweight 3. The cover body 51 has a rectangular shape. Each side of one of the two pairs of sides of the rectangular shape in the cover body 51 is disposed along the left-and-right direction. Each side of the other pair of the two pairs of sides of the rectangular shape is disposed along the back and-forth direction. All of these edges are bent downwards.

The elastic member 52 is made of, for example, rubber. As shown in FIGS. 8B and 8C, the elastic member 52 is disposed at ends of the surface 51d that contacts the upper surface 33 of the cover body 51. The elastic members 52 are disposed along a side 51a on the rea side, a side 51b on the left side, and a side 51c on the right side of the cover body 51 shown in FIG. 8D. As shown in FIG. 8B, the elastic member 52 includes an attachment portion 521 and a buffer portion 522. The attachment portion 521 is a portion that is attached to the edge of the cover body 51. The elastic member 52 is attached to the cover body 51 by inserting the attachment portion 521 from below into the end bent downward of the cover body 51. The buffer portion 522 is cylindrical. When the opening 32a is closed by the upper surface cover 5, the buffer portion 522 abuts against the upper surface 33 around the opening 32a of the counterweight 3. By crushing the cylindrical shape of the buffer portion 522, the upper surface cover 5 and the upper surface 33 of the counterweight 3 are tightly attached to each other, so it is possible to prevent the intrusion of rainwater, soil, sand, etc. In addition, it is possible to suppress flapping of the upper surface cover 5. When the attachment/detachment device 4 is contracted, the upper surface cover 5 closes the opening 32a at the lowest position, but the lowest position includes fluctuation in the up-and-down direction due to the crushing allowance of the elastic member 52.

As shown in FIG. 8A, the spring support portion 53 is attached to the lower side of the cover body 51. The spring support portion 53 can be formed by bending a plate-shaped member. The spring support portion 53 has a U-shape. The spring support portion 53 includes a left side surface portion 531, a right side surface portion 532, and a flat portion 533.

As shown in FIG. 8C, the left side surface portion 531 is disposed to the left of the two left shoulder bolts 47. The left side surface portion 531 protrudes downward from the cover body 51. The left side surface portion 531 has a plate-shape. The left side surface portion 531 is disposed along the back-and-forth direction. The right side surface portion 532 is disposed to the right of the two right shoulder bolts 47. The right side surface portion 532 protrudes downward from the cover body 51. The right side surface portion 532 has a plate-shape. The right side surface portion 532 is disposed along the back-and-forth direction.

The flat portion 533 is disposed to connect the lower end of the left side surface portion 531 and the lower end of the right side surface portion 532. The flat portion 533 has a plate-shape. As shown in FIG. 8C, the flat portion 533 is disposed perpendicular to the up-and-down direction. The flat portion 533 has four through holes 53a formed along the up-and-down direction. A shoulder bolt 47 is passed through each through hole.

### Action

Next, explanation will be made for actions regarding attachment and detachment of the counterweight 3 in the hydraulic excavator 1 according to the present preferred embodiment.

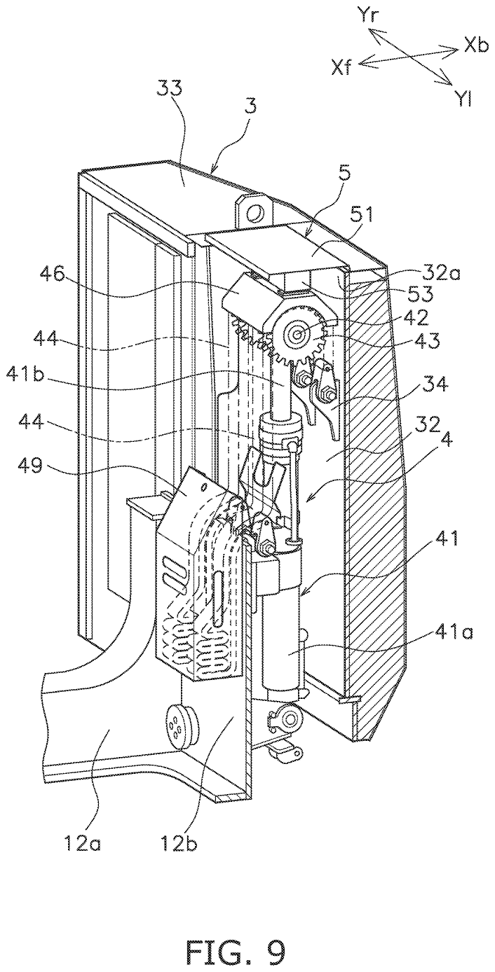

FIGS. 9, 10A, 10B, 11A, and 11B are views for explaining the action for detaching the counterweight 3 from the vehicle body 2.

FIG. 9 is a cross-sectional view of a condition that the counterweight 3 is attached to the vehicle body 2, while the opening 32a of the upper surface 33 thereof is closed by the upper surface cover 5. In the state shown in FIG. 9, the hydraulic excavator 1 is driven to perform a work or so forth. In the state, part of each chain 44, left without being wound, is accommodated in a storage box 49 disposed on the front side surface of the frame portion 12b.

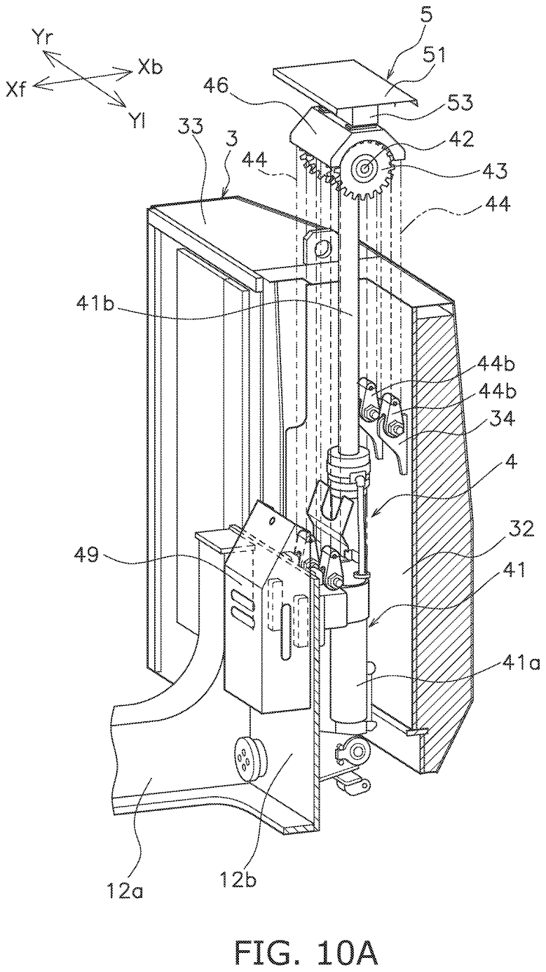

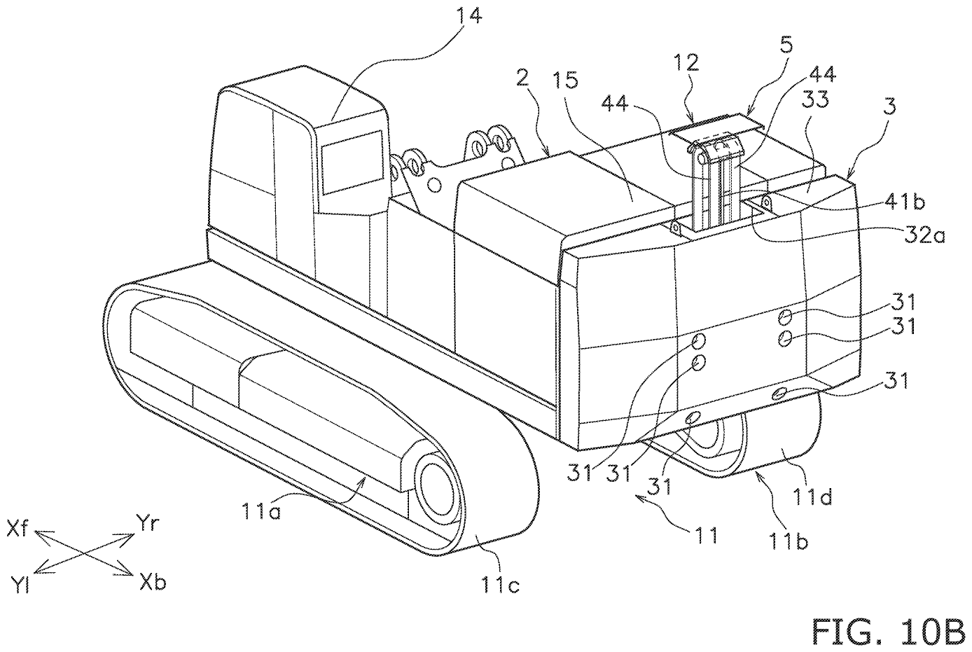

When the counterweight 3 is detached from the vehicle body 2, the cylinder 41 is expanded as shown in FIG. 10A. The hydraulic oil is supplied to the bottom-side space of the cylinder tube 41a, while the hydraulic oil, contained in the rod-side space of the cylinder tube 41a, is discharged therefrom; accordingly, the cylinder rod 41b is moved upward with respect to the cylinder tube 41a. With the expansion of the cylinder 41, the chains 44 are pulled out of the storage box 49, while the sprockets 43 are rotated. FIG. 10B is a perspective view of the vehicle body 2 in the expanded state of the cylinder 41.

In this state, the bolts, inserted into the through holes 31 perforated in the counterweight 3, are removed therefrom, whereby the counterweight 3 is released from being fastened to the frame portion 12b.

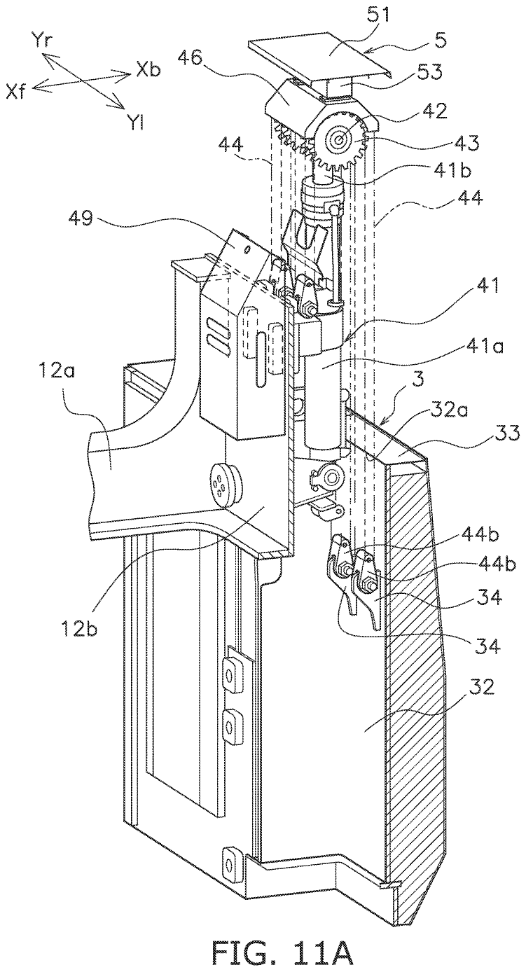

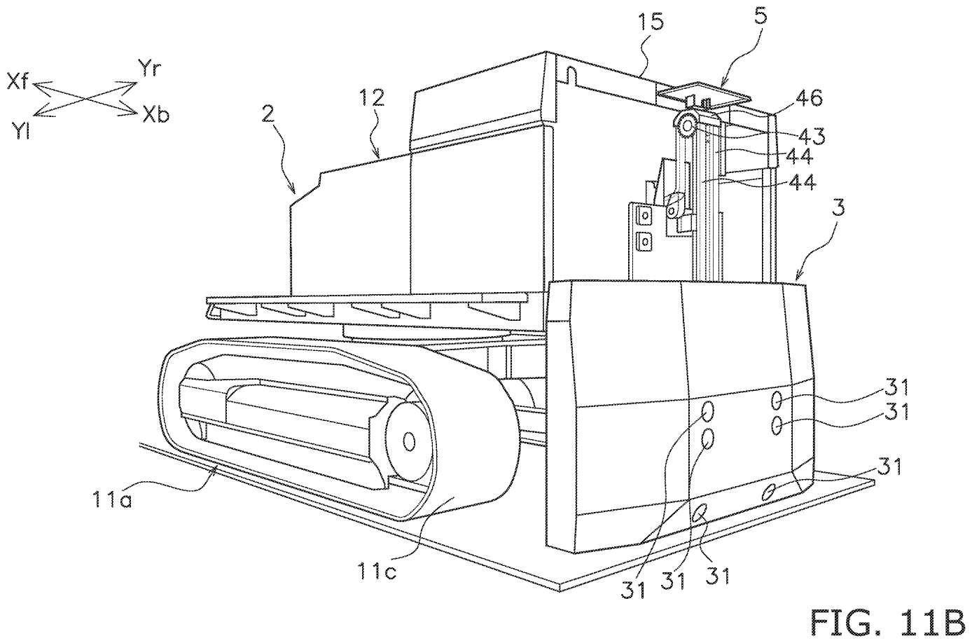

Next, as shown in FIG. 11A, the cylinder 41 is contracted. The hydraulic oil is supplied to the rod-side space of the cylinder tube 41a, while the hydraulic oil, contained in the bottom-side space of the cylinder tube 41a, is discharged therefrom, whereby the cylinder rod 41b is moved downward with respect to the cylinder tube 41a. With the contraction of the cylinder 41, the counterweight 3, connected to the end portions 44b of the chains 44, is moved downward, while the sprockets 43 are rotated. FIG. 11B is a perspective view showing the vehicle body 2 in a state in which the counterweight 3 has moved downward and is in contact with the ground.

Next, the other end portions 44b of the chains 44 and the brackets 34 are disconnected from each other. Accordingly, the counterweight 3 is enabled to be detached from the vehicle body 2.

It should be noted that an action for attaching the counterweight 3 to the vehicle body 2 is performed in an approximately reverse procedure to the above.

As shown in FIG. 11B, the counterweight 3 is disposed on the rear side of the vehicle body 2. Then, the end portions 44b of the chains 44 are connected to the brackets 34 of the counterweight 3.

Next, as shown in FIG. 10A, the cylinder 41 is expanded, whereby the counterweight 3 is lifted upward.

Next, the six bolts are inserted from behind into the six insertion holes 12c via the six through holes 31, respectively, whereby the counterweight 3 is fixed to the frame portion 12b.

Next, as shown in FIG. 9, the cylinder 41 is contracted, whereby part of each chain 44, left without being wound, is stored in the storage box 49 by the weight thereof, while the upper surface cover 5 closes the opening 32a of the counterweight 3.

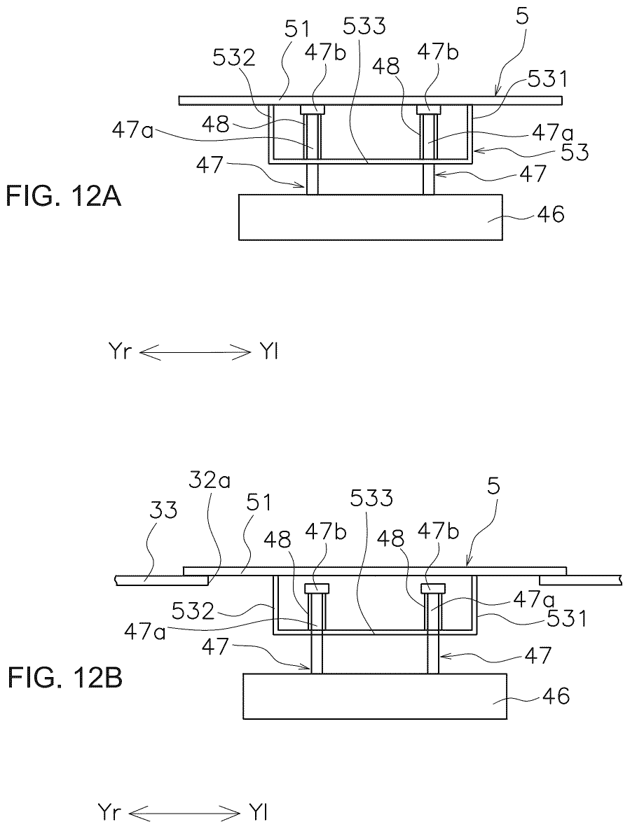

Here, the function of the spring 48 disposed on the shoulder bolt 47 will be described. FIG. 12A and FIG. 12B are schematic diagrams for explaining the function of the spring 48 disposed on the shoulder bolt 47.

FIG. 12A is a schematic diagram showing the upper part of the attachment/detachment device 4 and the upper surface cover 5. By contracting the cylinder 41 from this state, the upper surface cover 5 abuts against the upper surface 33 of the counterweight 3. At this time, even if the height position of the upper surface cover 5 when the cylinder 41 is contracted deviates from the height position of the upper surface 33 of the counterweight 3 due to manufacturing errors or the like, that deviation can be absorbed by the crushing allowance of the spring 48. As shown in FIG. 12B, even after the upper surface cover 5 abuts against the upper surface 33 of the counterweight 3, the shoulder bolt 47 is able to move downward together with the cylinder rod 41b by an amount equivalent to the crushing allowance of the spring 48. At this time, as shown in FIG. 12B, a gap may occur between the head portion 47b and the cover body 51. Therefore, even when the position of the upper surface cover 5 and the position of the upper surface 33 are misaligned due to manufacturing errors, the upper surface cover 5 can be tightly attached to the upper surface 33.

### Features, etc.

(1)

The hydraulic excavator 1 (exemplary work machine) according to the present preferred embodiment includes the vehicle body 2, the counterweight 3, the attachment/detachment device 4, and the upper surface cover 5. The counterweight 3 is attachable/detachable to/from the vehicle body 2. The attachment/detachment device 4 is disposed in the recessed portion 32 (exemplary storage portion) provided in the counterweight 3, with the counterweight 3 being attached to the vehicle body 2. The attachment/detachment device 4 expands/contracts in the up-and-down direction through the opening 32a provided above the recessed portion 32 in attachment/detachment of the counterweight 3 to/from the vehicle body 2. The upper surface cover 5 is attached to the attachment/detachment device 4, and moves up and down as the attachment/detachment device 4 extends and retracts, and closes the opening 32a at the lowest position.

In this way, by attaching the upper surface cover 5 to the attachment/detachment device 4, even when the hydraulic excavator 1 is operating with the opening 32a closed by the upper surface cover 5, the upper surface cover 5 is less likely to vibrate due to the weight of the attachment/detachment device 4, and flapping is suppressed.

This makes it possible to prevent rainwater and soil from entering through the opening 32a formed in the counterweight 3 due to the operation of the attachment/detachment device 4.
(2)

In the hydraulic excavator 1 according to the present preferred embodiment, the attachment/detachment device 4 includes the cylinder 41. The cylinder 41 extends and contracts in the up-and-down direction. The cylinder 41 includes the cylinder tube 41a and the cylinder rod 41b. The cylinder tube 41a is fixed to the vehicle body 2 along the up-and-down direction. The cylinder rod 41b moves upward relative to the cylinder tube 41a. The upper surface cover 5 is attached to the distal end of the cylinder rod 41b.

As a result, it is possible to close the opening 32a by the upper surface cover 5 by the cylinder rod 41b moving downward relative to the cylinder tube 41a. Furthermore, when the cylinder 41 is hydraulically operated, hydraulic fluid pressure is generated downward when the cylinder 41 is in a contracted state, so that flapping of the upper surface cover 5 can be further suppressed.
(3)

In the hydraulic excavator 1 according to the present preferred embodiment, the attachment/detachment device 4 further includes the sprocket 43 and the chain 44. The sprocket 43 is rotatably disposed at the distal end of the cylinder rod 41b. The chain 44 is connected to the vehicle body 2 and the counterweight 3 and is wound around the sprocket 43.

This allows the counterweight 3 connected to the chain 44 to move up and down as the cylinder 41 expands and contracts.
(4)

In the hydraulic excavator 1 according to the present preferred embodiment, the attachment/detachment device 4 further includes the sprocket cover 46. The sprocket cover 46 is disposed at the distal end of the cylinder rod 41b so as to cover the upper side of the sprocket 43. The upper surface cover 5 is disposed above the sprocket cover 46 and is attached to the distal end of the cylinder rod 41b via the sprocket cover 46.

By providing a sprocket cover 46 that covers the sprocket 43, it is possible to prevent the chain 44 from falling off the sprocket 43 due to the expansion and contraction of the cylinder 41.
(5)

In the hydraulic excavator 1 according to the present preferred embodiment, the attachment/detachment device 4 includes the shoulder bolt 47 (exemplary support member), the sprocket cover 46 (exemplary fixing portion), the spring 48 (exemplary elastic member), and the spring support portion 53 (exemplary elastic member support portion). The shoulder bolt 47 has as rod-shape, is disposed below the upper surface cover 5, and supports the upper surface cover 5. The sprocket cover 46 fixes the shoulder bolt 47 to the distal end of the cylinder rod 41b. The spring 48 is disposed around the shoulder bolt 47. The spring support portion 53 supports the spring 48 from below, includes the through hole 53a through which the shoulder bolt 47 passes, and is fixed to the upper surface cover 5. The shoulder bolt 47 includes the rod-shaped portion 47a (an example of a penetrating portion) and a head portion 47b. The rod-shaped portion 47a passes through the through hole 53a. The head portion 47b is disposed above the rod-shaped portion 47a. The spring 48 is disposed between the head portion 47b and the spring support portion 53.

This allows the upper surface cover 5 to be tightly attached to the upper surface 33 of the counterweight 3 using the crushing allowance of the spring 48, more reliably preventing rainwater, soil, sand, etc. from entering through the opening 32a.
(6)

In the hydraulic excavator 1 according to the present preferred embodiment, the attachment/detachment device 4 further includes the shaft member 42 and the bearing 143. The shaft member 42 is disposed at the distal end of the cylinder rod 41b. The bearing 143 is press-fitted into the through hole 43a of the sprocket 43 through which the shaft member 42 passes.

This reduces the sliding resistance of the sprocket 43 against the shaft member 42, allowing the sprocket 43 to rotate smoothly and improving the storability of the chain 44.
(7)

In the hydraulic excavator 1 according to the present preferred embodiment, the counterweight 3 includes the upper surface 33 in which the opening 33a is formed. The upper surface cover 5 includes the elastic member 52 disposed at the end of the surface 51d that contacts the upper surface 33.

This ensures that the upper surface cover 5 and the upper surface 33 of the counterweight 3 are in close contact with each other, preventing the intrusion of rainwater, soil, sand, etc. In addition, it is possible to suppress flapping of the upper surface cover 5.

### Other Preferred Embodiments

One preferred embodiment of the present invention has been explained above. However, the present invention is not limited to the preferred embodiment described above, and a variety of changes can be made without departing from the gist of the present invention.
(A)

In the preferred embodiment described above, the cylinder 41 is used as an expansion/contraction mechanism for the attachment/detachment device 4; besides, the hydraulic cylinder is exemplified as the cylinder 41. However, the cylinder 41 may not be limited in configuration to this; instead, an electric cylinder may be used as the cylinder 41. Besides, the expansion/contraction mechanism may not be limited to the cylinder; instead, such an actuator as being configured to slide in expansion and contraction may be used as the expansion/contraction mechanism.
(B)

In the preferred embodiment described above, the sprockets 43 and the chains 44 are used as the attachment/detachment device 4; however, the attachment/detachment device 4 is not limited in configuration to this. For example, pulleys, wires, and so forth may be used as the attachment/detachment device 4.
(C)

In the preferred embodiment described above, the upper surface cover 5 is attached to the cylinder 41 via the sprocket cover 46, but the sprocket cover 46 may not be provided and the upper surface cover 5 may be attached directly to the cylinder 41.
(D)

In the preferred embodiment described above, explanation has been made by exemplifying the hydraulic excavator as the work vehicle; however, the work machine is not limited to the hydraulic excavator. The present invention is applicable to another type of work machine provided with a counterweight such as a wheel loader.

According to the present disclosure, it is made possible to provide a work machine capable of preventing the intrusion of rainwater, soil, sand, and the like through an opening formed in a counterweight, which is useful for hydraulic excavators and the like.

1. A work machine comprising:
a vehicle body;
a counterweight attachable to and detachable from the vehicle body;
an attachment and detachment device disposed in a storage portion provided in the counterweight, with the counterweight being attached to the vehicle body, the attachment and detachment device expanding and contracting in an up-and-down direction through an opening provided above the storage portion in attachment of the counterweight to and detachment of the counterweight from the vehicle body; and
an upper surface cover attached to an upper side of the attachment and detachment device, the upper surface cover being configured to move in the up-and-down direction as the attachment and detachment device extends and retracts, the upper surface cover being configured to close the opening at a lowest position.

2. The work machine according to claim 1, wherein
the attachment and detachment device includes a cylinder configured to expand and contract in the up-and-down direction, and the cylinder includes
a cylinder tube fixed to the vehicle body in the up-and-down direction, and
a cylinder rod configured to move upward relative to the cylinder tube, and
the upper surface cover is attached to a distal end of the cylinder rod.

3. The work machine according to claim 2, wherein
the attachment and detachment device further includes
a sprocket rotatably disposed at the distal end of the cylinder rod, and
a chain connected to the vehicle body and the counterweight, the chain being wound around the sprocket.

4. The work machine according to claim 3, wherein
the attachment and detachment device further includes a sprocket cover disposed at the distal end of the cylinder rod so as to cover an upper side of the sprocket, and
the upper surface cover is disposed above the sprocket cover and is attached to the distal end of the cylinder rod via the sprocket cover.

5. The work machine according to claim 2, wherein
the attachment and detachment device includes
a support member having a rod-shape, the support member being disposed under the upper surface cover, the support member supporting the upper surface cover,
a fixing portion fixing the support member to the distal end of the cylinder rod,
an elastic member disposed around the support member, and
an elastic member support portion supporting the elastic member from below, the elastic member support portion including a through hole through which the support member passes, the elastic member support portion being fixed to the upper surface cover,
the support member includes a penetrating portion passing through the through hole and a head portion disposed above the penetrating portion, and
the elastic member is disposed between the head portion and the elastic member support portion.

6. The work machine according to claim 3, wherein
the attachment and detachment device further includes
a shaft member disposed at the distal end of the cylinder rod, and
a bearing press-fitted into a through hole of the sprocket through which the shaft member passes.

7. The work machine according to claim 1, wherein
the counterweight includes an upper surface in which the opening is formed, and
the upper surface cover includes an elastic member disposed at an end of a surface configured to contact the upper surface.
